(19) United States
(12) Patent Application Publication
(10) Pub. No.: US 2003/0202354 A1
(43) Pub. Date: Oct. 30, 2003

(54) Waterproof structure for miniature lamp bulbs

(75) Inventor: Shwu-Miin Lin, Taipei (TW)

Correspondence Address: BRUCE H. TROXELL, 5205 LEESBURG PIKE, SUITE 1404, FALLS CHURCH, VA, 22041, US

(73) Assignee: Shining Blick Enterprises Co., Ltd.

(21) Appl. No.: 10/128,487

(22) Filed: Apr. 24, 2002

(51) Int. Cl. B60Q 3/04

(52) U.S. Cl. 362/362

(57) ABSTRACT

An improved waterproof structure for a miniature lamp bulb, whereof, the lamp bulb is assembled on a seat portion, two polar pins are exposed to the laterals outside of the seat portion to be insertion connected with a receptacle. The receptacle is provided with a round connecting pipe portion connecting the lamp bulb and the seat portion. A protecting cover is tightly assembled on the round connecting pipe portion for protecting the lamp bulb. At least a waterproof gasket is provided between the protecting cover and the round connecting pipe portion, hence the structure is a firmer and more reliable structure, and has a more ideal waterproofing function with high safety.

### BACKGROUND OF THE INVENTION

1. Field of the Invention

The present invention is related to an improved waterproof structure for a miniature lamp bulb, and especially to an improved waterproof structure suiting a miniature lamp bulb with an ideal outdoor waterproofing function to be used on a lamp string.

2. Description of the Prior Art

A conventional miniature lamp bulb used for a decorative lamp string is provided with an insertion seat portion, the seat portion can be inserted into a receptacle, the two polar pins of the lamp bulb are exposed to the laterals outside of the seat portion; so that when they are connected with the receptacle, they are connected with the electric power through metallic contacting pieces.

In such a conventional miniature decorative lamp bulb, the lamp bulb/the seat portion and the receptacle are two parts manufactured separately, a metallic contact portion is provided at the connecting area between them; when they are placed outdoors for a long period of time, a danger of water permeation may occur, thereby, a design for an improved waterproof structure is necessary. However, such a miniature decorative lamp bulb is made by mass production, the waterproofing function between the miniature lamp bulb and the receptacle has been unable to get an ideal effect.

### SUMMARY OF THE INVENTION

The object of the present invention is to provide an improved waterproof structure for a miniature lamp bulb, it is a firmer and more reliable structure in connecting the miniature lamp bulb and the receptacle thereof, and can have a more ideal waterproofing function, it can be used outdoors for longer time with durability and high safety.

To get the above stated object, the receptacle of the present invention is provided with a round connecting pipe portion for connecting the lamp bulb and its seat portion. A protecting cover is tightly assembled on the round connecting pipe portion for protecting the lamp bulb. In the preferred embodiment, the protecting cover is provided in the hollow inner bore thereof with an inner knurled peripheral surface with a height equal to that of the round connecting pipe portion, and at least a waterproof gasket is provided between the protecting cover and the round connecting pipe portion.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view of a preferred embodiment of the present invention;

FIG. 2 is an analytic perspective view showing the elements of the embodiment of FIG. 1;

FIG. 3 shows the cross section of FIG. 1;

FIG. 4 is a sectional view showing a longitudinal section of FIG. 1;

FIG. 5 is a sectional view taken in the direction 5-5 from FIG. 3;

FIG. 6 is a schematic view showing the operation of detaching the protecting cover of the present invention with a simple tool.

### DETAILED DESCRIPTION OF THE PREFERRED EMBODIMENT

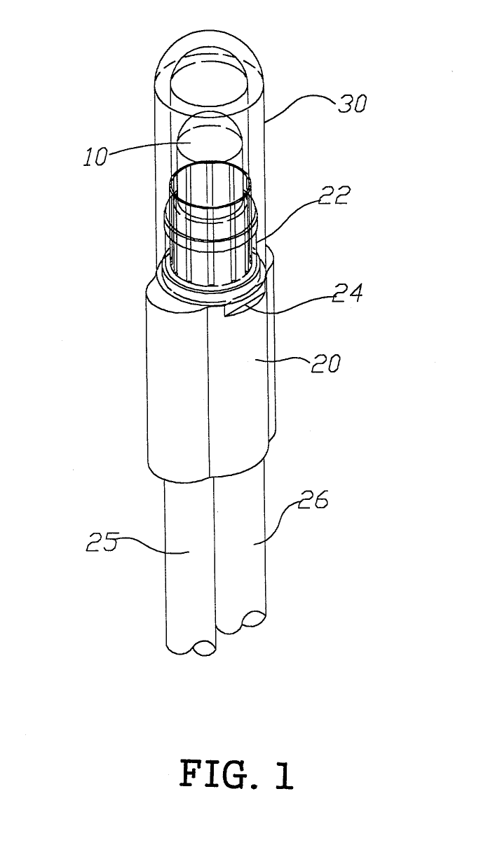

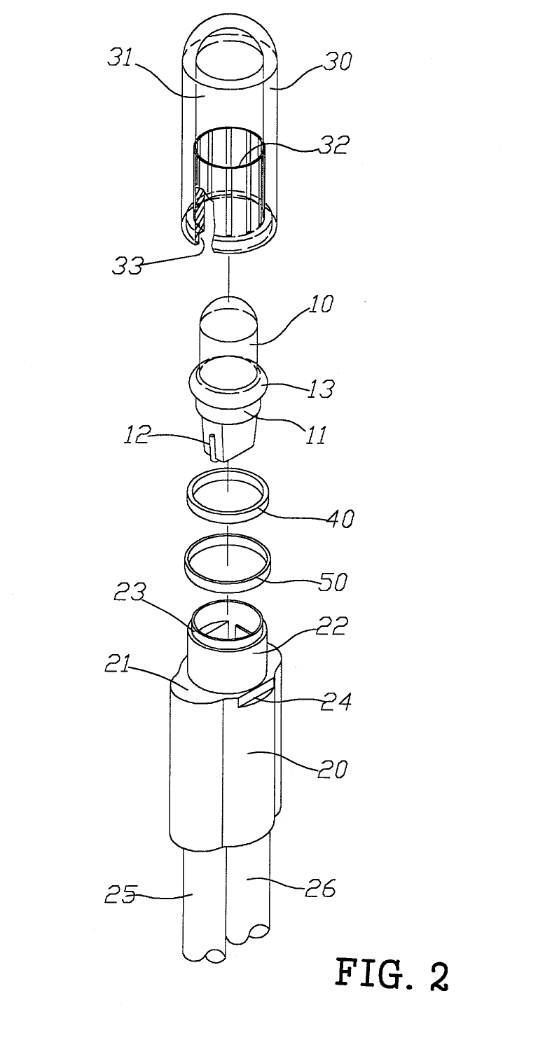

Referring to FIGS. 1, 2, in the miniature lamp bulb 10 as an example, its glass main body is assembled on the insulation seat portion 11, the two polar pins 12 of the lamp bulb 10 are exposed to the laterals outside of the seat portion 11 to be insertion connected with corresponding holes on a receptacle 20.

In the preferred embodiment shown in the drawings, the receptacle 20 of the present invention is provided with a raised round connecting pipe portion 22. The round connecting pipe portion 22 forms a stepped portion 23 on the external surface on the top end thereof, and two lateral recessed portions 24 are provided on but slightly lower than the bottom of a top end face 21 of the receptacle 20.

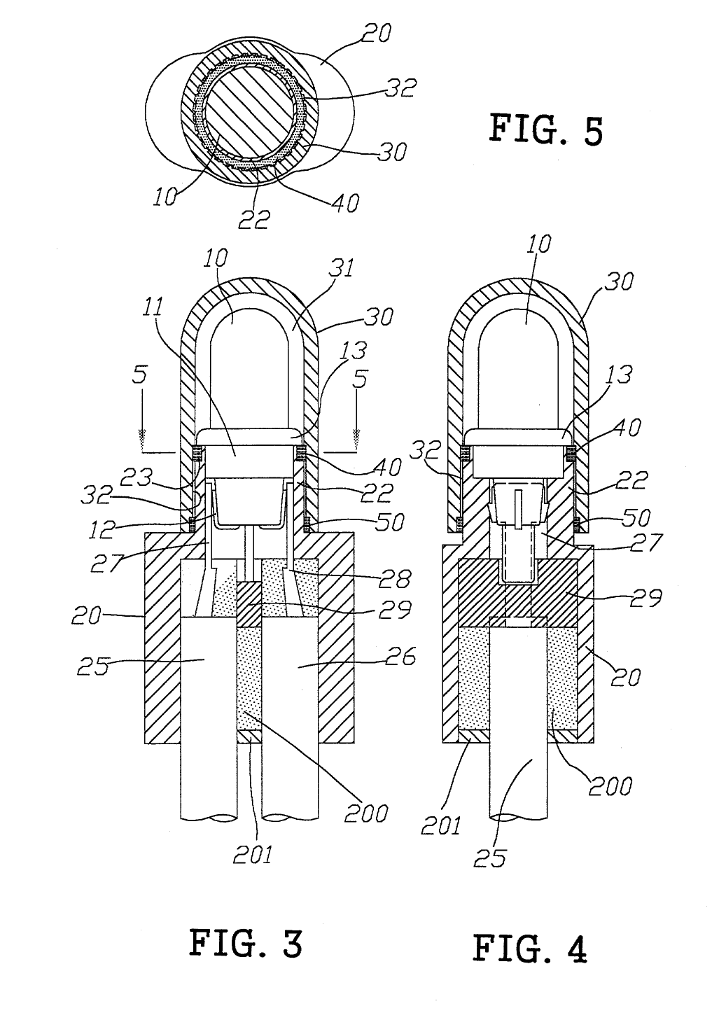

A transparent protecting cover 30 with a solid top surface has a hollow inner bore 31 facing downwardly (referring to FIGS. 3-5). The hollow inner bore 31 facing downwardly of the protecting cover 30 has an inner diameter identical to the external diameter of the round connecting pipe portion 22, so that it can be slipped over the round connecting pipe portion 22. In the preferred embodiment shown in the drawings, the inner bore 31 of the protecting cover 30 is provided therein with an inner knurled peripheral surface 32 with a predetermined height equal to that of the round connecting pipe portion 22. And an inner indented stepped portion 33 is provided on the bottom end of the inner knurled peripheral surface 32.

And in the preferred embodiment shown in the drawings, at least a waterproof gasket is provided between the protecting cover 30 and the round connecting pipe portion 22 of the receptacle 20. In this preferred embodiment, the round connecting pipe portion 22 had better be provided with a first gasket 40 at the external stepped portion 23, the first gasket 40 is elastically pressed to abut among the inner peripheral surface of the protecting cover 30, the external surface of the round connecting pipe portion 22 and an annular ring 13 on the insulation seat portion 11 of the lamp bulb.

In the preferred embodiment shown, a second gasket 50 can be provided between the top end face 21 of the receptacle 20 and inner indented stepped portion 33 of the protecting cover 30.

As shown in FIG. 3, in the preferred embodiment, the receptacle 20 with conductors 25, 26 therein together with a plug member 29 is dealt with a plastic pouring operation and added with a bottom cover 201 to form a more perfect waterproof structure. Under such a situation, the metallic cores (or metallic connecting contact pieces) 27, 28 of the conductors 25, 26 are electrically connected with the two polar pins 12 of the lamp bulb 10 in a sealed state.

By assembling the protecting cover 30 over the lamp bulb 10 to form an ideal obscuring and protecting function, the inner knurled peripheral surface 32 of the protecting cover 30 can form a more tight connecting function with the round connecting pipe portion 22 of the receptacle 20; and in cooperating with the first gasket 40 and the second gasket 50, an effect of multiple waterproofing can be obtained.

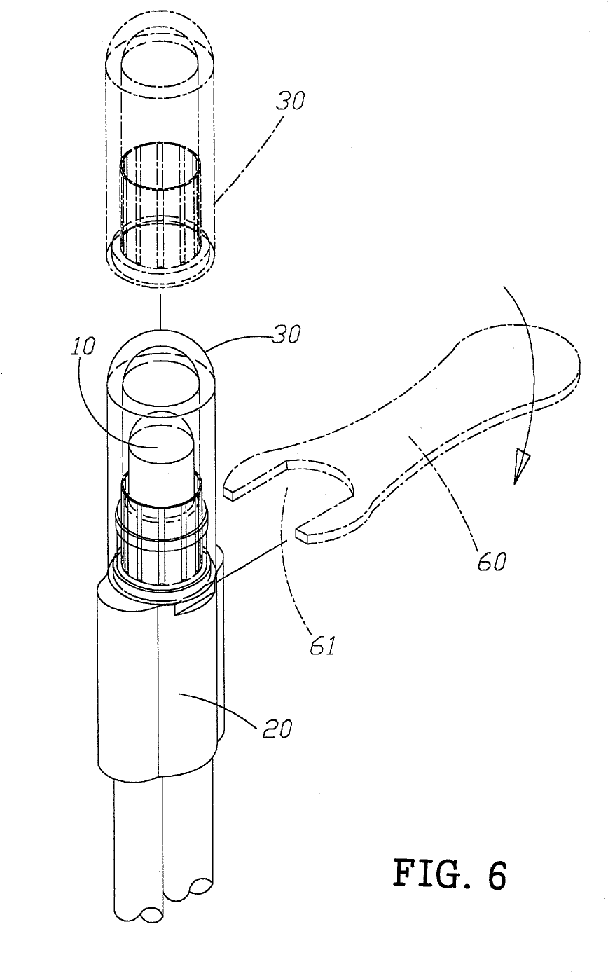

As shown in FIG. 6, by virtue that assembling of the present invention is firmer and more reliable, when it is necessary to detach the protecting cover 30 to change the lamp bulb 10 or for some other repairing work, just by using a simple tool 60 with a wrench opening 61 over the two lateral recessed portions 24 provided on the receptacle 20, the protecting cover 30 can be detached.

The present invention thereby is firmer and more reliable, has an excellent waterproofing function, and is more durable in using outdoors and has a higher safety.

The embodiment cited above is only for illustrating a preferred embodiment. It will be apparent to those skilled in this art that various modifications or changes without departing from the spirit and scope of the present invention can be made to and shall fall within the scope of the appended claims of the present invention.

1. An improved waterproof structure for a miniature lamp bulb, said structure comprises:
a lamp bulb assembled on an insulation seat portion, an annular ring being provided on said insulation seat portion, two polar pins being provided on said lamp bulb and exposed to the laterals outside of said seat portion;
a receptacle for insertion connecting said lamp bulb, being provided with a raised round connecting pipe portion thereon;
a transparent protecting cover with a solid top surface and a hollow inner bore facing downwardly, said hollow inner bore being tightly press connected with the external peripheral surface of said round connecting pipe portion of said receptacle to protect said lamp bulb; and
at least a waterproof gasket provided between the inner peripheral surface of said protecting cover and said round connecting pipe portion of said receptacle.

2. The improved waterproof structure as claimed in claim 1, wherein, said inner peripheral surface of said protecting cover is provided therein with an inner knurled peripheral surface with a predetermined height equal to that of said round connecting pipe portion of said receptacle.

3. The improved waterproof structure as claimed in claim 1, wherein, said at least a waterproof gasket includes a first waterproof gasket, said round connecting pipe portion of said receptacle forms a stepped portion on the external surface on the top end thereof for receiving said first waterproof gasket.

4. The improved waterproof structure as claimed in claim 1, wherein,
said at least a waterproof gasket includes a first waterproof gasket and a second waterproof gasket, said round connecting pipe portion of said receptacle forms a stepped portion on the top end on said external surface thereof for receiving said first waterproof gasket, and an inner indented stepped portion is provided on the bottom end of the opening of said protecting cover for receiving said second waterproof gasket.

5. The improved waterproof structure as claimed in claim 3 or 4, wherein,
said first gasket is arranged among said inner peripheral surface of said protecting cover, said external surface of said round connecting pipe portion and said annular ring on said insulation seat portion of said lamp bulb.

6. The improved waterproof structure as claimed in claim 1, wherein, two lateral recessed portions are provided on said receptacle near the connection area thereof with said round connecting pipe portion said to be acted by a force with a tool.

7. The improved waterproof structure as claimed in claim 1, wherein,
said receptacle has conductors therein with a plug member provided between said conductors in order to proceed to a plastic pouring operation for waterproofing.
